(19) United States
(12) Patent Application Publication
(10) Pub. No.: US 2024/0203110 A1
(43) Pub. Date: Jun. 20, 2024

(54) METHOD AND APPARATUS FOR FUSING SENSOR INFORMATION

(71) Applicants: HYUNDAI MOTOR COMPANY, Seoul (KR); KIA CORPORATION, Seoul (KR)

(72) Inventor: Seong Hwan Kim, Seoul (KR)

(73) Assignees: HYUNDAI MOTOR COMPANY, Seoul (KR); KIA CORPORATION, Seoul (KR)

(21) Appl. No.: 18/511,691

(22) Filed: Nov. 16, 2023

(30) Foreign Application Priority Data
Dec. 16, 2022 (KR) 10-2022-0176864

(51) Int. Cl. G06V 10/80; G06V 20/58

(52) U.S. Cl. CPC G06V 10/811; G06V 20/58

(57) ABSTRACT

A sensor information fusion device includes a camera sensor and a processor configured to fuse sensor information obtained from the camera sensor and recognize an object. The processor is configured to determine whether a sensor fusion track is included in a region of interest (ROI) of a camera and whether camera data associated with the camera sensor is detected in the sensor fusion track. The processor is also configured to update classification information of the sensor fusion track based on a result of the determining.

### CROSS-REFERENCE TO RELATED APPLICATION

This application claims the benefit of and priority to Korean Patent Application No. 10-2022-0176864, filed on Dec. 16, 2022, the entire contents of which are hereby incorporated herein by reference.

### TECHNICAL FIELD

The present disclosure relates to a sensor information fusion method and device, and more particularly, to a sensor information fusion method and device that may improve the classification performance of a sensor fusion track.

### BACKGROUND

Recent advancement in autonomous driving systems is promoting the development and wider applications of object recognition technology using multiple types of sensors. To apply object tracks output sensors to sensor fusion, various methods of combining and fusing sensor information are in development.

Tracks output from various sensors for sensor fusion may include various information. There is ongoing research and development of new and various methods for improving the accuracy of output information such as track position, speed, and class.

A typical technology may perform association by gating output information of cameras and/or radar/lidar sensors and reference points, and performing sensor fusion by selecting sensor information of sensors with relatively high accuracy of sensor information. A class of each sensor fusion track may be selected using class information, which may be classification information provided by the sensor.

Because the typical technology may classify classes by selecting sensor information, the class information may change frequently according to a combination of associated sensors. For example, in a case in which one of a plurality of associated sensors is dissociated, class information of the remaining associated sensors may be selected and updated thereby, and a class may thus change.

### SUMMARY

An object of the present disclosure is to provide a sensor information fusion method and device that determines a class age and estimates a confidence of a class based on the determined class age, thereby improving the classification performance of a sensor fusion track.

The sensor information fusion method and device may reduce the probability of a change of the class of the sensor fusion track based on the determined class age and prevent a change to a dissimilar class through comparison with a previous class, thereby improving the classification performance of the sensor fusion track.

According to an embodiment of the present disclosure, a sensor information fusion device is provided. The sensor information fusion device includes a camera sensor and a processor. The processor is configured to fuse sensor information obtained from the camera sensor and recognize an object. The processor is configured to determine whether a sensor fusion track is included in a region of interest (ROI) of a camera and whether camera data obtained by the camera sensor is associated with the sensor fusion track. The processor is also configured to update classification information of the sensor fusion track based on a result of the determining.

In an aspect, the processor may include an ROI checking unit configured to output a first check signal when the sensor fusion track overlaps within the ROI of the camera. The processor may also include a sensor association unit configured to output a first association signal when the first check signal is output and the camera data is associated with the sensor fusion track. The processor may further include a class update unit configured to determine a class age when the sensor fusion track is associated with the camera sensor, and update the classification information of the sensor fusion track based on the determined class age. The processor may further include a class fixing unit configured to determine whether a class is in a fixed state based on the determined class age. The processor may further still include a class conversion unit configured to, when the fixed state of the class is canceled, apply the updated classification information through current class conversion.

In an aspect, the class age may have a weight that varies according to a position or performance of the camera sensor.

In an aspect, the class update unit may determine the class age based on a point in time at which the camera data is updated, not on logic driving.

In an aspect, the class fixing unit may, when the determined class age is greater than or equal to a preset reference parameter, set a class at a current time to be in the fixed state.

In an aspect, the class update unit may include a class comparison unit configured to determine a camera class age when the sensor fusion track is associated with the camera data, and determine a lidar/radar class age when the sensor fusion track is associated with data obtained by a lidar/radar sensor. The class comparison unit may also compare and analyze the determined camera class age and the determined lidar/radar class age.

In an aspect, the class comparison unit may, when the camera class age is greater than the lidar/radar class age as a result of the comparing and analyzing, update a camera class.

In an aspect, the class comparison unit may, when the camera class age is less than the lidar/radar class age as a result of the comparing and analyzing, update a lidar/radar class.

In an aspect, the class comparison unit may update current classification information in a pre-class info matrix to compare histories of a camera class or a lidar/radar class.

In an aspect, the class comparison unit may perform the updating by applying the determined camera class age or the determined lidar/radar class age to classification information stored at a previous time to compare the histories of the camera class or the lidar/radar class.

According to another embodiment of the present disclosure, a sensor information fusion method is provided. The sensor information fusion method may be performed using a sensor information fusion device including a processor. The sensor information fusion method may include determining, using the processor, whether a sensor fusion track is included in an ROI of a camera. The sensor information fusion method may also include, when the sensor fusion track is included in the ROI of the camera as a result of the determining, determining whether camera data obtained by a camera sensor is associated with the sensor fusion track. The sensor information fusion method may further include updating classification information of the sensor fusion track based on a result of the determining.

In an aspect, determining whether the sensor fusion track is in the ROI of the camera may include outputting a first check signal when the sensor fusion track overlaps in the ROI of the camera.

In an aspect, determining whether the camera data is associated with the sensor fusion track may include, when the first check signal is output and the camera data is associated with the sensor fusion track, outputting a first association signal.

In an aspect, updating the classification information of the sensor fusion track may include, when the sensor fusion track is associated with the camera data, determining a class age and updating the classification information of the sensor fusion track based on the determined class age. Updating the classification information of the sensor fusion track may also include determining whether a class is in a fixed state based on the determined class age. Updating the classification information of the sensor fusion track may further include, when the fixed state of the class is canceled, applying the updated classification information through current class conversion.

In an aspect, the class age may have a weight that varies according to a position or performance of the camera sensor.

In an aspect, updating the classification information of the sensor fusion track based on the determined class age may include determining the class age based on a point in time at which the camera data is updated, not on logic driving.

In an aspect, determining whether the class is in the fixed state may include, when the determined class age is greater than or equal to a preset reference parameter, setting a class at a current time to be in the fixed state.

In an aspect, applying the updated classification information may include determining a camera class age when the sensor fusion track is associated with the camera data, and determining a lidar/radar class age when the sensor fusion track is associated with data obtained by a lidar/radar sensor. Applying the updated classification information may also include comparing and analyzing the determined camera class age and the determined lidar/radar class age.

In an aspect, comparing and analyzing the determined camera class age and the determined lidar/radar class age may include, when the camera class age is greater than the lidar/radar class age as a result of the comparing and analyzing, updating a camera class, or when the camera class age is less than the lidar/radar class age as the result of the comparing and analyzing, updating a lidar/radar class.

In an aspect, comparing and analyzing the determined camera class age and the determined lidar/radar class age may include updating current classification information in a pre-class info matrix to compare histories of the camera class or the lidar/radar class, or updating the current classification information by applying the determined camera class age or the determined lidar/radar class age to classification information stored at a previous time to compare the histories of the camera class or the lidar/radar class.

A sensor information fusion method and device according to an embodiment of the present disclosure may estimate a confidence of a class based on a class age, thereby improving the classification performance of a sensor fusion track.

The sensor information fusion method and device may reduce the probability of a change of a class of the sensor fusion track through the class age and prevent a change of the class to a dissimilar class through comparison with a previous class, thereby improving the classification performance of the sensor fusion track.

### BRIEF DESCRIPTION OF THE DRAWINGS

The above and other objects, features and advantages of the present disclosure should be more apparent from the following detailed description taken in conjunction with the accompanying drawings, in which:

FIG. 1 is a block diagram illustrating a vehicle including a sensor information fusion device, according to an embodiment.

FIG. 2 is a schematic block diagram illustrating a sensor information fusion device, according to an embodiment.

FIG. 3 is a schematic block diagram illustrating a configuration of a fusion track setting unit, according to an embodiment.

FIG. 4 is a diagram illustrating an operation of a class update unit, according to an embodiment.

FIG. 5 is a diagram illustrating a sensor information fusion method, according to an embodiment.

FIG. 6 is a diagram illustrating another sensor information fusion method, according to another embodiment.

FIG. 7 is a diagram illustrating a sensor fusion track generated by the sensor information fusion method of FIGS. 5 and 6, according to embodiments.

### DETAILED DESCRIPTION

Hereinafter, embodiments of the present disclosure are described in detail with reference to the accompanying drawings to facilitate understanding of the present disclosure. However, various modifications and changes may be made to the embodiments, and the scope of the present disclosure should not be construed as being limited to the embodiments described below. The embodiments of the present disclosure are provided to give more complete explanations to one having ordinary skill in the art to which the present disclosure pertains.

In the description of the embodiments, when an element is described as being formed “on” or “under” another element, it may be construed that the two elements are in direct contact or the two elements are in indirect contact with one or more other elements disposed therebetween.

In addition, when an element is described as being “on” or “under” another element, it may be construed that such an expression includes an upward direction and/or a downward direction with respect to the other element.

Relational terms such as “first” and “second,” and “above/upper/on” and “below/lower/under” may be used herein to refer to distinguish one entity or element from another, without necessarily requiring or connoting any physical or logical relationship or sequence therebetween.

When a component, device, element, or the like of the present disclosure is described as having a purpose or performing an operation, function, or the like, the component, device, or element should be considered herein as being “configured to” meet that purpose or perform that operation or function.

Hereinafter, sensor information fusion methods and devices according to embodiments of the present disclosure are described in detail with reference to the accompanying drawings.

Although the sensor information fusion methods and devices are generally described herein using the Cartesian coordinate system (x-axis, y-axis, and z-axis) for convenience, it may also be described using other coordinate systems. In addition, although the x-axis, the y-axis, and the z-axis are orthogonal to each other according to the Cartesian coordinate system, examples are not limited thereto. For example, the x-axis, the y-axis, and/or the z-axis may or may not cross each other.

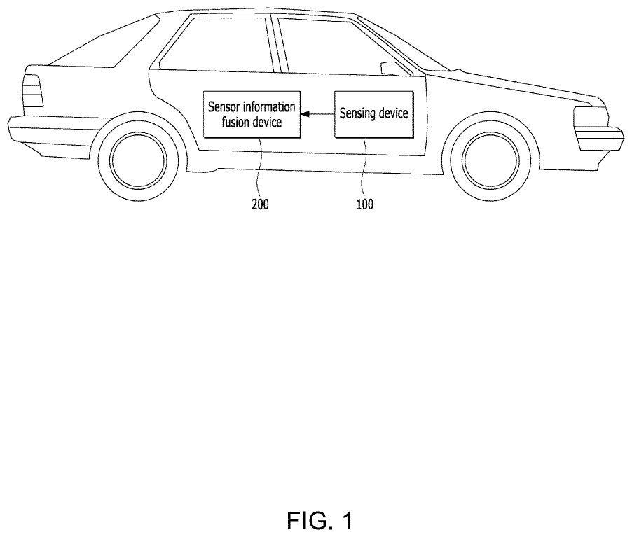

FIG. 1 is a block diagram illustrating a vehicle including a sensor information fusion device, according to an embodiment.

Referring to FIG. 1, a vehicle may include a sensing device 100 configured to detect an object present outside the vehicle. The vehicle may also include a sensor information fusion device 200 configured to fuse sensor information obtained from the sensing device 100 and recognize the object.

The sensing device 100 may include one or more sensors configured to obtain information about a target object present around the vehicle. The sensing device 100 may obtain at least one set of information such as a position, a moving speed, a moving direction, and a type (e.g., a vehicle, a pedestrian, a bicycle, a motorcycle, and the like) of the target object according to a type of the sensor. The sensing device 100 may include various sensors, such as, for example, an ultrasonic sensor, a radio detection and ranging (radar) sensor, a camera, a laser scanner, a light detection and ranging (lidar) sensor, a near vehicle detection (NVD) sensor, and the like.

The sensor information fusion device 200 may include a processor 201 configured to control operation of the sensor information fusion device 200.

The processor 201 may detect an object by processing a detection point input from each sensor of the sensing device 100, and may predict sets of track information based on the detected object. The sensor information fusion device 200 may determine the same object by varying a weight using a distance and an overlapping range between the predicted sets of track information. When the same object is determined, the sensor information fusion device 200 may fuse sensor information of the sensors to generate fusion track information.

The processor 201 may determine whether the generated sensor fusion track is associated with a region of interest (ROI) of a camera and a camera sensor, and may update classification information of the fusion sensor track or previous classification information based on a result of the determining. The processor 201 may also determine a confidence of classification information based on the updated information, and may set whether a class is fixed. The processor 201 may compare current classification information included in the set class and classification information stored at a previous time, and may output final classification information.

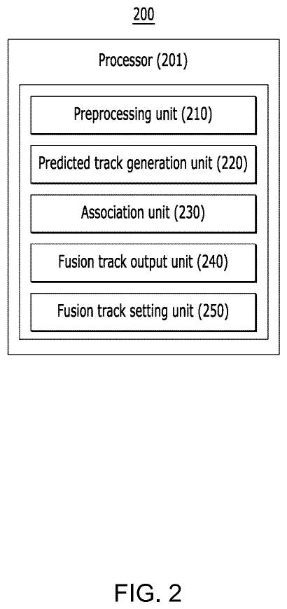

FIG. 2 is a schematic block diagram illustrating a sensor information fusion device according to an embodiment.

Referring to FIG. 2, the processor 201 may include a preprocessing unit 210, a predicted track generation unit 220, an association unit 230, a fusion track output unit 240, and a fusion track setting unit 250.

The preprocessing unit 210 may process detection points input from respective sensors into a form available to be fused. The preprocessing unit 210 may correct coordinate systems of sets of sensing data obtained from the respective sensors to be the same reference coordinate system. In addition, the preprocessing unit 210 may remove, through filtering, one or more detection points having data intensity or confidence values below a reference value.

The predicted track generation unit 220 may detect an object by processing the detection points input from the respective sensors, and may predict sets of track information based on the detected object. A track described herein may be generated in the form of a box that fits an outline of an object. The track may include information such as a position, a speed, a class, and the like.

For one object, one track may be output per sensor. However, even when the same object is sensed, there may be differences in attributes such as size, position, speed, and the like of a track generated according to the characteristics of each sensor.

The association unit 230 may determine a similarity between tracks generated by the respective sensors and fuse the tracks into a single fusion track. For example, the association unit 230 may update a target sensor fusion track to be associated among gated sensor tracks. The association unit 230 may apply a distance between a reference track and an associated track and a characteristic of an overlapping area, i.e., a geometric characteristic of the two tracks, to determine a combined cost, thereby generating a sensor fusion track having the highest similarity to a real object.

The fusion track output unit 240 may output and manage the sensor fusion track generated by the association unit 300.

The fusion track setting unit 250 may determine whether the generated sensor fusion track is associated with an ROI of a camera and a camera sensor. The fusion track output unit 240 may then update classification information of the sensor fusion track or previous classification information based on whether the generated sensor fusion track is associated with an ROI of the camera and the camera sensor.

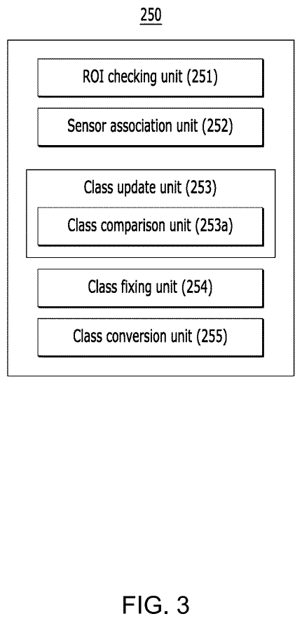

The fusion track setting unit 250 may set whether a class is fixed by determining a confidence of the classification information based on the updated classification information of the sensor fusion track or the updated previous classification information. As described in more detail below with reference to FIG. 3, the fusion track setting unit 250 may output final classification information by comparing current classification information included in the set class and the previous classification information stored at a previous time.

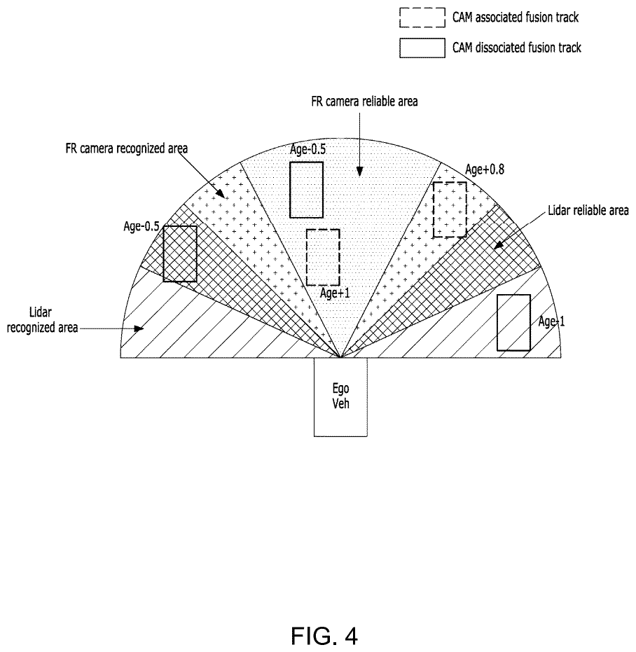

FIG. 3 is a schematic block diagram illustrating a configuration of a fusion track setting unit, according to an embodiment. FIG. 4 is a diagram illustrating an operation of a class update unit, according to an embodiment.

Referring to FIG. 3, the fusion track setting unit 250 may include an ROI checking unit 251, a sensor association unit 252, a class update unit 253, a class fixing unit 254, and a class conversion unit 255.

The ROI checking unit 251 may check whether the generated sensor fusion track is included in the ROI of the camera. The ROI checking unit 251 may thus output a check signal differently depending on whether or not sensor fusion tracks generated within the ROI of the camera overlap. The check signal may include a first check signal or a second check signal. For example, the ROI checking unit 251 may output the first check signal when the generated sensor fusion track is included in, or overlaps, the ROI of the camera. On the other hand, the ROI checking unit 251 may output the second check signal when the generated sensor fusion track is not included in, or does not overlap, the ROI of the camera.

The sensor association unit 252 may check whether the sensor fusion track is associated with the camera when the generated sensor fusion track overlaps within the ROI of the camera. For example, when the first check signal is provided from the ROI checking unit 251, the sensor association unit 252 may determine whether the camera sensor is associated with the sensor fusion track. The sensor association unit 252 may then output an association signal based on a result of the determination of whether the camera sensor is associated with the sensor fusion track. The association signal may include a first association signal or a second association signal.

For example, the sensor association unit 252 may output the first association signal when the first check signal is output and camera data associated with the camera sensor is detected in the sensor fusion track. On the other hand, the sensor association unit 252 may output the second association signal when the first check signal is output and the camera data related to the camera sensor is not detected in the sensor fusion track. The first association signal may also be referred to herein as a true signal, and the second association signal may also be referred to herein as a false signal.

The class update unit 253 may update the classification information of the sensor fusion track when the sensor fusion track is associated with the camera sensor.

The class update unit 253 may determine a class age in consideration of positions and performance of camera sensors or various sensors installed in the vehicle. The class age may have a weight that varies depending on the positions or performance of the camera sensors or the various sensors. For example, the class update unit 253 may set weights as shown in Table 1 below by varying the weights according to the positions or performance of the camera sensors or the various sensors. However, examples are not limited thereto, and the weights shown in Table 1 may be set differently depending on a state of the vehicle, a speed of the vehicle, an environment around the vehicle, a traffic situation of the vehicle, and the like.

TABLE 1

Age by classification performance section

| Sensor | Reliable area | Recognized area |
|---|---|---|
| PR Camera | 1 | 0.8 |
| PSIR | 0.3 | 0.1 |
| RSIR | 1 | 0.8 |
| PSOD | 1 | 0.5 |
| RIR | 0.8 | 0.5 |
| Lidar | −0.5 | −1 |
| Radar | −0.8 | −1 |

The class update unit 253 may classify the various sensors or the camera sensors into ages by each classification performance section. Age by classification performance section may include a recognized area and a reliable area. The recognized area may be defined as an entire area in which the various sensors or the camera sensors may recognize an object. The reliable area, which may be a part of the recognized area, may be defined as an area in which a sensor result is reliable. The reliable area may be an area in the recognized area in which a sensor result value is included within a preset reference range.

The various sensors or the camera sensors may include an FR camera, an FSIR, an RSIR, an FSOD, an RIR, a lidar, a radar, and the like.

Referring to FIG. 4, the class update unit 253 may set different class age weights depending on the recognized/reliable area of each sensor.

For example, the class update unit 253 may determine a class age by applying a weight of 1 in a case of a reliable area of an FR camera, and determine a class age by applying a weight of 0.8 in a case of a recognized area of the FR camera. The class update unit 253 may determine a class age by applying a weight of minus (−) 0.5 in a case of a reliable area of a lidar, and determine a class age by applying a weight of minus (−) 1 in a case of a recognized area of the lidar.

The class update unit 253 may determine the class age based on an actual sensor data update time, not on logic driving.

The class update unit 253 may update current classification information in a pre-class info matrix to compare class histories. For example, the class update unit 253 may apply the determined class age to classification information stored at a previous time to compare class histories and update the classification information.

The class update unit 253 may include a class comparison unit 253a. The class comparison unit 253a may be configured to determine a camera class age when the sensor fusion track is associated with the camera sensor. The class comparison unit 253a may also be configured to determine a lidar/radar class age when the sensor fusion track is associated with a lidar/radar sensor. The class comparison unit 253a may further be configured to compare and analyze the determined camera class age and the determined lidar/radar class age.

The class comparison unit 253a may update the camera class when the camera class age is higher than the lidar/radar age as a result of the comparing and analyzing. The class comparison unit 253a may additionally or alternatively update the lidar/radar class when the camera class age is lower than the lidar/radar class age as the result of the comparing and analyzing.

The class comparison unit 253a may update the current classification information in the pre-class info matrix to compare camera class or lidar/radar class histories.

For example, to compare the camera class or lidar/radar class histories, the class comparison unit 253a may apply the determined camera class age or the determined lidar/radar class age to the classification information stored at the previous time and may then update the classification information.

The class fixing unit 254 may determine whether a class is in a fixed state based on the determined class age. The class fixing unit 254 may determine a confidence of the classification information of the sensor fusion track based on the determined class age. The class fixing unit 254 may then determine whether the class is in the fixed state based on the confidence of the classification information of the sensor fusion track.

In an example, when the determined class age is greater than or equal to a preset reference parameter, the class fixing unit 254 may set a class at a current time to be in the fixed state.

In addition, when a track with a class fixed at a previous time is present within the ROI of the camera and the class age is less than or equal to the preset reference parameter, the class fixing unit 254 may set the class that was in the fixed state at the previous time to be a state that is not fixed at the current time. Accordingly, the class fixing unit 254 may cancel the class previously in the fixed state based on the current time.

The class fixing unit 254 may apply the most recently updated classification information of a sensor to the class with the fixed state being canceled.

The class conversion unit 255 may compare the current classification information and the previous classification information to determine final classification information, and may output the determined final classification information. When the class age satisfies a preset condition or criterion, the class conversion unit 255 may maintain the class in the fixed state to be class information at a corresponding time.

On the other hand, for a class with the fixed state being canceled, the class conversion unit 255 may apply the currently updated classification information through current class conversion.

The class conversion unit 255 may compare accumulated previous class classification information and current class classification information. When there is a difference between the previous class classification information and the current class information, the class conversion unit 255 may verify that it is the same as the newly updated class classification information over a certain number of times (e.g., a parameter). The class conversion unit 255 may then convert the class classification information. For example, as shown in Table 2 below, the class conversion unit 255 may change the number of checks of the previous class. However, examples are not limited thereto. For example, similar classification information such as PV/CV may be output as a general car class in an intermediate process in which a class conversion occurs.

TABLE 2

| | Previous | Previous | | Previous | |
|---|---|---|---|---|---|
| Current | [1] | [2] | . . . | [n] | Final |

| | | | | | |
|---|---|---|---|---|---|
| 1 | PED | CVC or | CVC or | CVC or | CVC or |
| | | PTV | PTV | PTV | PTV |
| 2 | PV | CV | CV | CV | Car |
| 3 | PV | PV | CV | CV | Car |
| 4 | PV | PV | PV | CV | PV |
| 5 | PED | PED | PED | PED | PED |

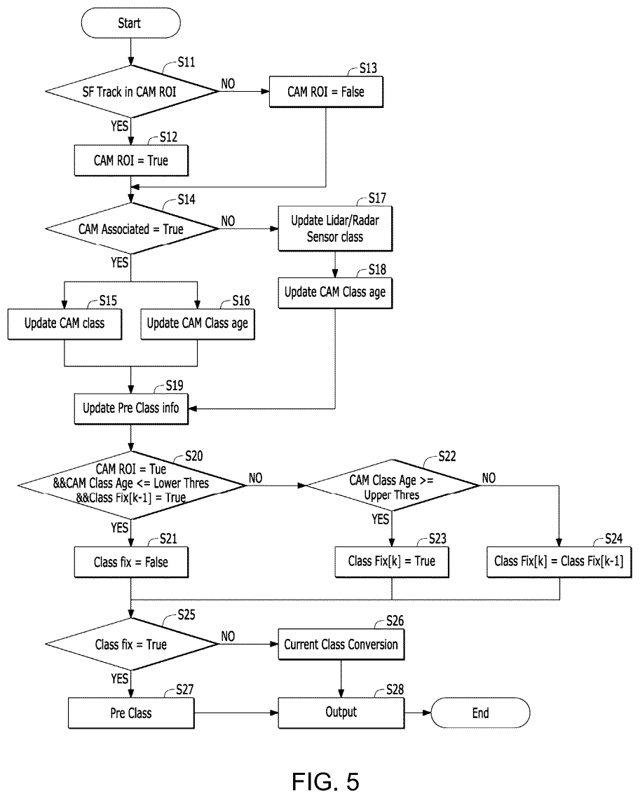

FIG. 5 is a diagram illustrating a sensor information fusion method, according to an embodiment.

Referring to FIG. 5, the sensor information fusion device described herein, according to an embodiment, may operate as follows.

In a step or operation S11, the processor 201 may check whether a generated sensor fusion track is included in an ROI of a camera.

In a step or operation S12, when the generated sensor fusion track is included in or overlaps the ROI of the camera (yes in S11), the processor 201 may determine such a case as “true.” In a step or operation S13, when the generated sensor fusion track is not included in or does not overlap the ROI of the camera (no in S11), the processor 201 may determine such a case as “false.”

In a step or operation S14, when the generated sensor fusion track overlaps within the ROI of the camera, the processor 201 may check whether the sensor fusion track is associated with the camera.

In steps or operations S15 and S16, when the sensor fusion track is associated with a camera sensor (yes in S14), the processor 201 may determine and update a class associated with the camera sensor and a class age in consideration of positions, performance, and the like of various sensors or the camera sensor provided in the vehicle.

In a step or operation S17, when the sensor fusion track is not associated with the camera sensor (no in S14), the processor 201 may update a class associated with a lidar/radar sensor.

In a step or operation S18, the processor 201 may determine and update a class age in consideration of positions, performance, and the like of various sensors or the camera sensor provided in the vehicle.

A class age may have a weight that varies according to positions or performances of various sensors or camera sensors. This has been fully described above with reference to FIGS. 3 and 4, and thus a repeated and more detailed description thereof is omitted here.

The processor 201 may determine the class age based on an actual sensor data update time, not on logic driving.

In a step or operation S19, the processor 201 may update current classification information in a pre-class info matrix to compare class histories.

The pre-class info matrix may include variables having current to previous class information. For example, information at a current time k may be denoted as [0], information at a previous time k-1 may be denoted as [1], and information at a previous time k-2 may be denoted as [2]. However, examples are not limited thereto.

In a step or operation S20, the processor 201 may determine whether a class is in a fixed state based on the determined class age. The processor 201 may determine a confidence of the classification information of the sensor fusion track based on the determined class age. The processor 201 may then determine whether the class is in the fixed state based on the confidence of the classification information.

In a step or operation S21, when a track with the class already fixed at a previous time is present within the ROI of the camera and the class age is less than or equal to a preset minimum parameter (yes in S20), the processor 201 may set the class that was in the fixed state at the previous time to be one that is not in the fixed state at the current time. Accordingly, in the step or operation S21, the processor 201 may cancel the class previously in the fixed state based on the current time. When the camera class age, or the CAM class age, is less than or equal to a lower threshold, the processor 201 may determine that the confidence of the class that was in the fixed state at the previous time has been degraded. Accordingly, the processor 201 may cancel the class that was previously in the fixed state, based on the current time, to apply the most recently updated class information of the sensors.

In a step or operation S22, the processor 201 may determine whether the determined class age is greater than or equal to a preset maximum parameter.

In a step or operation S23, when the determined class age is greater than or equal to the preset maximum parameter (yes in S22), the processor 201 may set a class of the current time k to be in the fixed state.

In a step or operation S24, when the determined class age is greater than or equal to the preset maximum parameter (no in S22), the processor 201 may maintain a class of the previous time k-1 to continue being in the fixed state.

In a step or operation S25, the processor 201 may determine whether the class is fixed.

In a step or operation S27, when the class is in the fixed state (yes in S25) as a result of the determination, the processor 201 may compare the current classification information and the previous classification information and determine final classification information. For example, when it is determined that the previous classification information is reliable as a result of the determination, the processor 201 may maintain the previous classification information.

In a step or operation S28, the processor 201 may output the determined final classification information.

In a step or operation S26, when the class is in a canceled state (no in S25) as the result of the determination, the processor 201 may apply currently updated classification information through current class conversion.

In a step or operation S28, the processor 201 may output the final classification information by applying the currently updated classification information.

As described above, the sensor information fusion device 200 according to an embodiment may determine a class age and estimate a confidence of a class based on the determined class age, thereby improving the classification performance of a sensor fusion track.

The sensor information fusion device 200 according to an embodiment may reduce a probability of a change in the class of the sensor fusion track through the determined class age and prevent the class from being changed to a dissimilar class through comparison with a previous class, thereby improving the classification performance of the sensor fusion track.

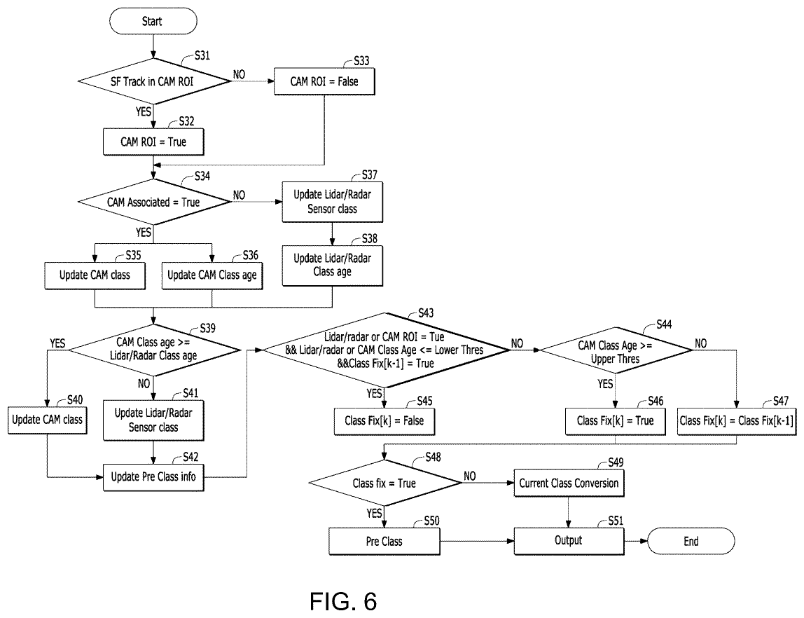

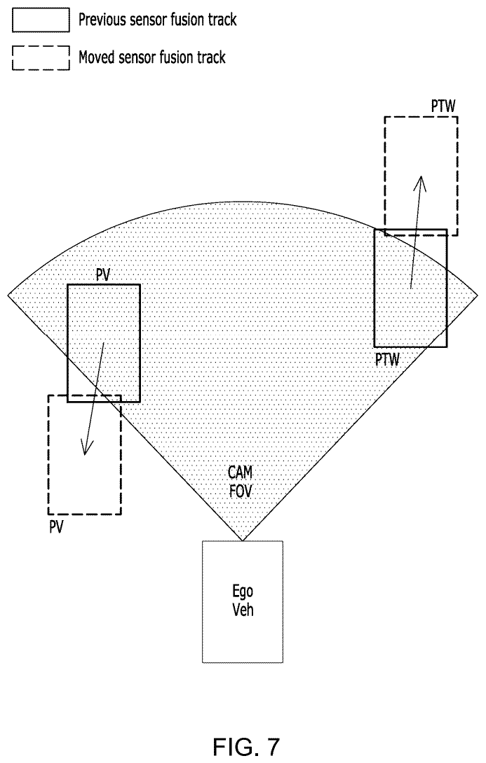

FIG. 6 is a diagram illustrating a sensor information fusion method, according to another embodiment. FIG. 7 is a diagram illustrating a sensor fusion track generated by the sensor information fusion method of FIGS. 5 and 6, according to embodiments.

Referring to FIG. 6, the sensor information fusion device described herein, according to an embodiment, may operate as follows.

In a step or operation S31, the processor 201 may check whether a generated sensor fusion track is included in an ROI of a camera.

In a step or operation S32, when the generated sensor fusion track is included in or overlaps the ROI of the camera (yes in S31), the processor 201 may determine such a case as “true.” In a step or operation S33, when the generated sensor fusion track is not included in or does not overlap the ROI of the camera (No in S31), the processor 201 may determine such a case as “false.”

In a step or operation S34, when the generated sensor fusion track overlaps within the ROI of the camera, the processor 201 may check whether the sensor fusion track is associated with the camera.

In steps or operations S35 and S36, when the sensor fusion track is associated with a camera sensor (yes in S34), the processor 201 may determine and update a camera class age in consideration of a class associated with the camera sensor and positions, performances, and the like of various sensors or camera sensors provided in the vehicle.

In a step or operation S37, when the sensor fusion track is not associated with the camera sensor (no in S34), the processor 201 may update a class associated with a lidar/radar sensor.

In a step or operation S38, the processor 201 may determine and update a lidar/radar class age in consideration of a position, performance, and the like of the lidar/radar sensor provided in the vehicle.

The processor 201 may determine the class age based on an actual sensor data update time, not on logic driving.

In a step or operation S39, the processor 201 may compare and analyze the camera class age and the lidar/radar class age, and may vary class histories in response to a result of the comparison and analysis. For example, in a step or operation S40, the processor 201 may update the camera class when the camera class age is higher than the lidar/radar class age as the result of the comparison and analysis. In a step or operation S41, the processor 201 may update the lidar/radar class age when the camera class age is lower than the lidar/radar class age as the result of the comparison and analysis.

In an example, the processor 201 may compare and analyze the camera class age and the lidar/radar class age and select a higher value as the result of the comparison and analysis.

In a step or operation S42, the processor 201 may update current classification information in a pre-class info matrix to compare camera class or lidar/radar class histories. The pre-class info matrix may include variables having current to previous class information. For example, information at a current time k may be denoted as [0], information at a previous time k-1 may be denoted as [1], and information at a previous time k-2 may be denoted as [2]. However, examples are not limited thereto.

In a step or operation S43, the processor 201 may determine whether a class is in a fixed state based on the determined class age. The processor 201 may determine a confidence of the classification information of the sensor fusion track based on the determined class age, and may determine whether the class is in the fixed state based on this.

In a step or operation S45, when a track with the camera class or the lidar/radar class already fixed at a previous time is present within the ROI of the camera (true in S43) and the camera class age or the lidar/radar class age is less than or equal to a preset minimum parameter (yes in S43), the processor 201 may set the camera class or the lidar/radar class that was in the fixed state at the previous time to be one that is not in the fixed state at a current time. Accordingly, the processor 201 may cancel the camera class or the lidar/radar class that was previously in the fixed state, based on the current time in the step or operation S45.

In other words, when the camera class age (or the CAM class age) or the lidar/radar class age is less than or equal to a lower threshold, the processor 201 may determine that a confidence of the class that was in the fixed state at the previous time has been degraded. Accordingly, the processor 201 may cancel the class that was previously in the fixed state, based on the current time, to apply the most recently updated class information of the sensors.

In a step or operation S44, the processor 201 may determine whether the determined camera class age or the determined lidar/radar class age is greater than or equal to a preset maximum parameter.

In a step or operation S46, when the determined camera class age or the determined lidar/radar class age is greater than or equal to the preset maximum parameter (yes in S45), the processor 201 may set a class of the fusion track of the current time k to be in the fixed state.

In a step or operation S47, when the determined camera class age or the determined lidar/radar class age is less than or equal to the preset maximum parameter (no in S45), the processor 201 may maintain the class of the fusion track at the current time k to be in a state at a previous time k-1.

In a step or operation S48, the processor 201 may determine whether the camera class or the lidar/radar class is fixed.

In a step or operation S50, when the class is in the fixed state (yes in S48) as a result of the determination, the processor 201 may compare the current classification information and the previous classification information and determine final classification information. For example, when it is determined that the previous classification information is reliable as the result of the determination, the processor 201 may maintain the previous classification information.

In a step or operation S51, the processor 201 may output the determined final classification information.

In a step or operation S49, when the class is in a canceled state (no in S48) as the result of the determination, the processor 201 may apply currently updated classification information through current class conversion.

In a step or operation S51, the processor 201 may output the final classification information by applying the currently updated classification information.

As described above, the sensor information fusion device 200 according to an embodiment may determine a camera class age or a lidar/radar class age and estimate a confidence of a camera class or a lidar/radar class based on the determined camera class age or the determined lidar/radar class age, thereby improving the classification performance of a sensor fusion track.

As shown in FIG. 7, in an embodiment, the sensor information fusion device 200 may reduce a probability of a change in the class of the sensor fusion track through the determined class age and prevent the class from being changed to a dissimilar class through comparison with a previous class, thereby improving the classification performance of the sensor fusion track.

The present disclosure described above may be embodied as computer-readable code on a medium in which a program is recorded. The computer-readable medium may include various types of recording devices in which data readable by a computer system is stored. Examples of the computer-readable medium include a hard disk drive (HDD), a solid-state drive (SSD), a silicon disk drive (SDD), a read-only memory (ROM), a random-access memory (RAM), a CD-ROM, a magnetic tape, a floppy disk, an optical data storage device, and the like.

Various embodiments described herein may be combined without departing from the object of the present disclosure and contradicting each other. In addition, among the various embodiments described herein, when components of one embodiment are not described in detail, descriptions of the components having the same reference numerals in other embodiments may be applied.

While the present disclosure has been described with various example embodiments, it should be apparent from an understanding of the disclosure that various modifications and changes in form and details may be made without departing from the spirit and scope of the claims and their equivalents. The examples described herein are to be considered in a descriptive sense only, and not for purposes of limitation. Therefore, in addition to the foregoing description, the scope of the disclosure may also be defined by the claims and their equivalents, and all variations within the scope of the claims and their equivalents are to be construed as being included in the disclosure.

What is claimed is:

1. A sensor information fusion device, comprising:
a camera sensor; and
a processor configured to fuse sensor information obtained from the camera sensor and recognize an object,
wherein the processor is configured to:
determine whether a sensor fusion track is located in a region of interest (ROI) of the camera sensor and whether camera data obtained by the camera sensor is associated with the sensor fusion track, and
update classification information of the sensor fusion track based on a result of the determining.

2. The sensor information fusion device of claim 1, wherein the processor comprises:
an ROI checking unit configured to output a first check signal when the sensor fusion track overlaps within the ROI of the camera sensor;
a sensor association unit configured to output a first association signal when the first check signal is output and the camera data is associated with the sensor fusion track;
a class update unit configured to:
determine a class age when the sensor fusion track is associated with the camera data; and
update the classification information of the sensor fusion track based on the class age;
a class fixing unit configured to determine whether a class is in a fixed state based on the class age; and
a class conversion unit configured to, when the fixed state of the class is canceled, apply the updated classification information through current class conversion.

3. The sensor information fusion device of claim 2, wherein the class age has a weight that varies according to a position or performance of the camera sensor.

4. The sensor information fusion device of claim 2, wherein the class update unit is configured to:
determine the class age based on a point in time at which the camera data is updated.

5. The sensor information fusion device of claim 2, wherein the class fixing unit is configured to:
when the determined class age is greater than or equal to a preset reference parameter, set a class at a current time to be in the fixed state.

6. The sensor information fusion device of claim 2, wherein the class update unit comprises:
a class comparison unit configured to:
determine a camera class age when the sensor fusion track is associated with the camera data;
determine a lidar/radar class age when the sensor fusion track is associated with a lidar/radar sensor; and
compare and analyze the determined camera class age and the determined lidar/radar class age.

7. The sensor information fusion device of claim 6, wherein the class comparison unit is further configured to:
when the camera class age is greater than the lidar/radar class age as a result of the comparing and analyzing, update a camera class.

8. The sensor information fusion device of claim 6, wherein the class comparison unit is further configured to:
when the camera class age is less than the lidar/radar class age as a result of the comparing and analyzing, update a lidar/radar class.

9. The sensor information fusion device of claim 6, wherein the class comparison unit is further configured to:
update current classification information in a pre-class info matrix to compare histories of a camera class or a lidar/radar class.

10. The sensor information fusion device of claim 9, wherein the class comparison unit is further configured to:
update the current classification information by applying the camera class age or the lidar/radar class age to classification information stored at a previous time to compare the histories of the camera class or the lidar/radar class.

11. A sensor information fusion method performed using a sensor information fusion device comprising a processor, the sensor information fusion method comprising:
determining, using the processor, whether a sensor fusion track is located in a region of interest (ROI) of a camera sensor;
when the sensor fusion track is located in the ROI of the camera sensor, determining whether camera data obtained by the camera sensor is associated with the sensor fusion track; and
updating classification information of the sensor fusion track based on a result of the determining.

12. The sensor information fusion method of claim 11, wherein determining whether the sensor fusion track is located in the ROI of the camera sensor includes:
outputting a first check signal when the sensor fusion track overlaps the ROI of the camera sensor.

13. The sensor information fusion method of claim 12, wherein determining whether the camera data is associated with the sensor fusion track includes:
when the first check signal is output and the camera data is associated with the sensor fusion track, outputting a first association signal.

14. The sensor information fusion method of claim 13, wherein updating the classification information of the sensor fusion track includes:
when the sensor fusion track is associated with the camera data, determining a class age and updating the classification information of the sensor fusion track based on the class age;
determining whether a class is in a fixed state based on the class age; and
when the fixed state of the class is canceled, applying the updated classification information through current class conversion.

15. The sensor information fusion method of claim 14, wherein the class age has a weight that varies according to a position or performance of the camera sensor.

16. The sensor information fusion method of claim 14, wherein updating the classification information of the sensor fusion track based on the class age includes:
determining the class age based on a point in time at which the camera data is updated.

17. The sensor information fusion method of claim 14, wherein determining whether the class is in the fixed state includes:
when the class age is greater than or equal to a preset reference parameter, setting a class at a current time to be in the fixed state.

18. The sensor information fusion method of claim 14, wherein applying the updated classification information includes:
determining a camera class age when the sensor fusion track is associated with the camera data, and determining a lidar/radar class age when the sensor fusion track is associated with a lidar/radar sensor; and
comparing and analyzing the camera class age and the lidar/radar class age.

19. The sensor information fusion method of claim 18, wherein comparing and analyzing the camera class age and the lidar/radar class age includes:
when the camera class age is greater than the lidar/radar class age, updating a camera class; or
when the camera class age is less than the lidar/radar class age, updating a lidar/radar class.

20. The sensor information fusion method of claim 18, wherein comparing and analyzing the camera class age and the lidar/radar class age includes:
updating current classification information in a pre-class info matrix to compare histories of a camera class or a lidar/radar class; or
updating the current classification information by applying the camera class age or the lidar/radar class age to classification information stored at a previous time to compare the histories of the camera class or the lidar/radar class.
